(19) United States
(12) Patent Application Publication
(10) Pub. No.: US 2009/0263763 A1
(43) Pub. Date: Oct. 22, 2009

(54) Denture Abutment & Retention System

(76) Inventor: John S. Shepard, Fort Collins, CO (US)

Correspondence Address: ANCEL W. LEWIS, JR., 425 WEST MULBERRY, SUITE 101, FORT COLLINS, CO, 80521, US

(21) Appl. No.: 12/488,677

(22) Filed: Jun. 22, 2009

Related U.S. Application Data
(63) Continuation-in-part of application No. 12/103,847, filed on Apr. 16, 2008.

(51) Int. Cl. A61C 8/00

(52) U.S. Cl. 433/174

(57) ABSTRACT

A denture retention system includes a denture and an abutment. The denture has an inner channel with an elastic liner having inserts. Each insert has an O-ring and a channel for capturing the O-ring. The abutment has a shaft, a head at one end of the shaft and a base at the other end of the shaft. The head has an undercut surface that extends radially outwardly from the shaft. The O-ring and undercut surface overlap and engage one another to retain the denture in the cavity. The abutment has a threaded portion at the other end of the shaft portion that threads into an implant or implants into a jaw, or a threaded aperture that receives a threaded portion on an implant.

This application is a continuation-in-part of Ser. No. 12/103,847 filed Apr. 16, 2008.

### TECHNICAL FIELD

The present invention relates to dentistry and more particularly to an abutment and system for releasably locating, supporting and retaining a denture.

### BACKGROUND ART

Dental implants are used to support one or more artificial teeth. Implants can help support, stabilize and retain full dentures. Suction aids retention of upper full dentures, but suction is generally inadequate for retention of lower full dentures.

Some prior known implants systems for dentures use a ball shaped abutment that projects from each implant. U.S. Pat. No. 4,787,851 to Kusano, et al. discloses a denture having an inner channel with an elastomeric liner and ball shaped abutments that project into the liner. U.S. Pat. No. 2,112,007 to Adams discloses a denture having an inner channel with snap ring cup sockets and ball shaped abutments that project into the sockets. U.S. Pat. No. 5,049,072 to Lueschen discloses a denture having an inner channel with sockets, o-rings and ball shaped abutments that project into the sockets.

Other prior known implants systems for dentures use two or more implants with abutments and a bar connecting the abutments. U.S. Pat. No. 5,678,997 to De Buck discloses abutments and a bar connecting the abutments, and a plastic rider connected to a denture that snaps onto the bar.

### DISCLOSURE OF THE INVENTION

A denture retention system includes a denture and at least two abutments. The denture has an inner channel with an elastic liner. The abutment has an abutment shaft portion with spaced first and second ends, an abutment head portion at the first end of the abutment shaft portion and a threaded portion that projects from the second end of the abutment shaft portion. The abutment head portion extends radially outwardly relative to the abutment shaft portion and has an undercut surface that extends transversely from the abutment shaft portion. A peripheral surface on the abutment head portion has a plurality of flats for engaging a tool to insert the abutment. The abutment head portion has a smooth, convex end surface. The threaded portion can be sized and shaped to thread into an implant or to thread directly into bone as an implant. The liner of the denture has a denture cavity for each abutment. The cavity has a shape complimentary to the shape of the abutment with a cavity shaft portion and a cavity head portion. The cavity head portion extends radially outwardly relative to the cavity shaft portion and has a ledge surface that extends transversely from the cavity shaft portion. The denture cavity deforms to receive with the undercut surface engaging the ledge surface to retain the denture.

### BRIEF DESCRIPTION OF THE DRAWINGS

Details of this invention are described in connection with the accompanying drawings that bear similar reference numerals in which:

FIG. 1 is a top plan view of a denture retaining system embodying features of the present invention.

FIG. 2 is a bottom plan view of a denture of the system of FIG. 1.

FIG. 3 is a sectional view of the system of FIG. 1 taken along line 3-3.

FIG. 4 is a side elevation view of an abutment of the system of FIG. 1.

FIG. 5 is a top plan view of the abutment of FIG. 4.

FIG. 6 is a bottom plan view of the abutment of FIG. 4.

FIG. 7 is a side elevation view of an implant for the abutment of FIG. 4.

FIG. 8 is a top plan view of the implant of FIG. 7.

FIG. 9 is a side elevation view of another abutment of the system of FIG. 1.

FIG. 10 is a side elevation view of a tool for insertion of the abutment of FIG. 4 or 9.

FIG. 11 is a top plan view of the tool of FIG. 10.

FIG. 12 is a bottom plan view of the tool of FIG. 10.

FIG. 13 is a top plan view of another denture retaining system embodying features of the present invention.

FIG. 14 is a bottom plan view of a denture of the system of FIG. 13.

FIG. 15 is a sectional view of the system of FIG. 13 taken along line 15-15 of FIG. 14.

FIG. 16 is a perspective view of an insert for the system of FIG. 13.

FIG. 17 is a bottom plan view of the insert of FIG. 16.

FIG. 18 is a sectional view of the insert of FIG. 16 taken along line 18-18 of FIG. 17.

FIG. 19 is a side elevation view of an abutment of the system of FIG. 13.

FIG. 20 is a top plan view of the abutment of FIG. 19.

FIG. 21 is a bottom plan view of the abutment of FIG. 19.

FIG. 22 is a side elevation view of an implant for the abutment of FIG. 19.

FIG. 23 is a top plan view of the implant of FIG. 22.

FIG. 24 is a side elevation view of a modified abutment of the system of FIG. 13.

FIG. 25 is a top plan view of the abutment of FIG. 24.

FIG. 28 is a top plan view of the implant of FIG. 27.

FIG. 29 is a side elevation view of another modified abutment of the system of FIG. 13.

FIG. 30 is a perspective view of another abutment insert for the system of FIG. 13.

FIG. 31 is a top plan view of the abutment insert of FIG. 30.

FIG. 32 is a sectional view of the abutment insert of FIG. 30 taken along line 32-32 of FIG. 31.

FIG. 33 is a bottom plan view of a denture of the system of FIG. 13 with another liner.

FIG. 34 is a sectional view of the system of FIG. 13 taken along line 34-34 of FIG. 33.

### DETAILED DESCRIPTION OF THE INVENTION

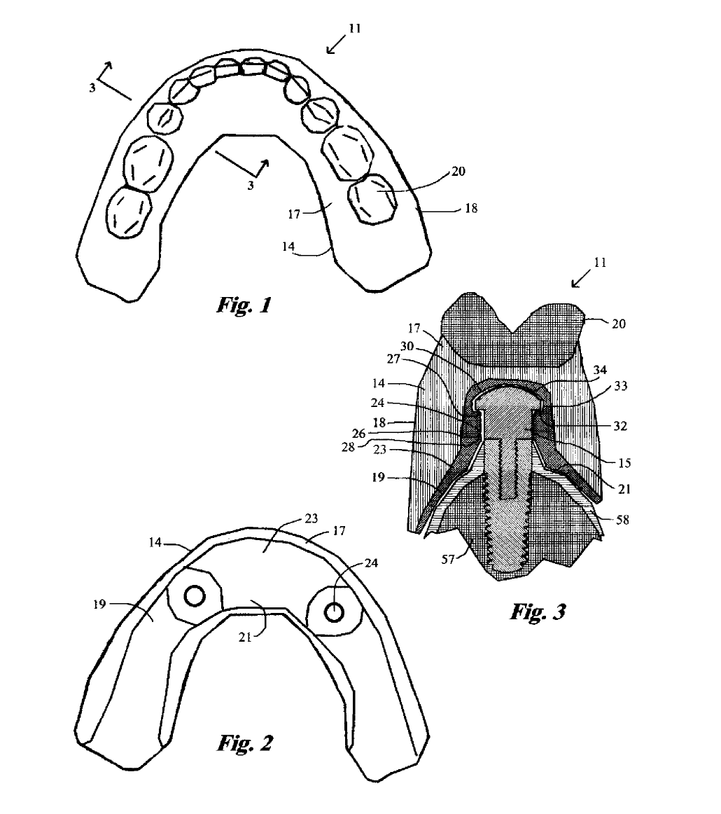

Referring now to FIGS. 1 to 3, a denture retention system 11 includes a denture 14 and abutments 15. The denture 14 has a body 17 with an outer side 18 and a spaced inner side 19. The outer side 18 is shaped to simulate the appearance of gums and a plurality of artificial teeth 20 are mounted on the outer side 18. The inner side 19 has an inner channel 21 that is shaped to receive the gums of a patient. The inner channel 21 includes an elastic liner 23. The liner 23 is made of an elastomer, a natural or synthetic elastic material. The liner is preferably made of a medical silicone. By way of example, and not as a limitation, the liner 23 can be made of Silastic Type A by Dow-Corning.

The liner 23 includes a plurality of spaced, shaped denture cavities 24 that extend inwardly from the inner side 19 toward the outer side 18 of the body 17. The denture cavities 24 are substantially symmetrically positioned relative to the body 17 of the denture 14 and generally two or four denture cavities 24 are provided. Each denture cavity 24 has a cavity shaft portion 26 with spaced first and second ends 27 and 28, and a cavity head portion 30 at the first end 27 of the cavity shaft portion 26. The cavity shaft portion 26 is substantially cylindrical. The second end 28 of the cavity shaft portion 26 opens in the direction away from the outer side 18 of the body 17 of the denture 14.

The cavity head portion 30 extends radially outwardly relative to the cavity shaft portion 26, and has a ledge surface 32, a peripheral surface 33 and an end surface 34. The ledge surface 32 extends transversely, radially outwardly from the first end 27 of the cavity shaft portion 26. The peripheral surface 33 extends transversely from the periphery of the ledge surface 32 to the periphery of the end surface 34. The end surface 34 is preferably concave with a smooth, uninterrupted, low profile dome shape.

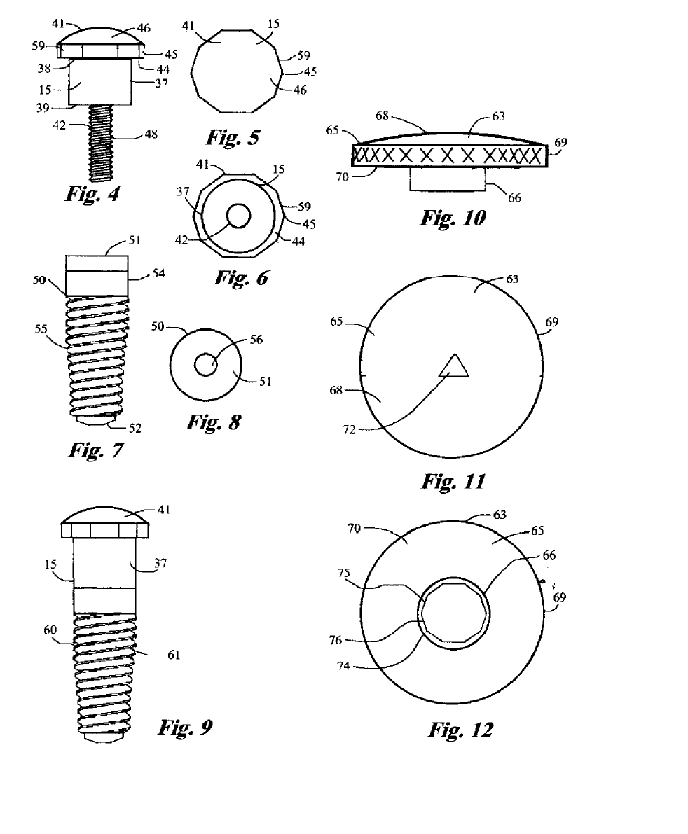

As shown in FIGS. 4 to 6, the abutment 15 includes an abutment shaft portion 37 with spaced first and second ends 38 and 39, an abutment head portion 41 attached to the first end 38 and a threaded portion 42 attached to the second end 39. The abutment shaft portion 37 is substantially cylindrical and the abutment head portion 41 projects radially outwardly relative to the abutment shaft portion 37. The abutment head portion 41 has an undercut surface 44 that extends transversely, radially outwardly from the first end 38 of the abutment shaft portion 37, a peripheral surface 45 that extends transversely from the periphery of the undercut surface 44, and an end surface 46, spaced from the undercut surface 44, that extends radially inwardly from the peripheral surface 45. The threaded portion 42 is cylindrical with external threads 48 and projects axially from the second end 39 of the abutment shaft portion 37.

FIGS. 7 and 8 show an implant 50 having spaced first and second ends 51 and 52. The first end 51 is flat. The implant 50 has a smooth, cylindrical surface 54 adjacent to the first end 51 and external threads 55 from the cylindrical surface 54 to the second end 52. A threaded aperture 56 extends into the implant 50 from the first end 51. The aperture 56 is sized and shaped to receive the threaded portion 42 of the abutment 15.

Referring again to FIG. 3, the cavity shaft portion 26 is sized to snugly fit around the abutment shaft portion 37, and the cavity head portion 30 is sized to snugly fit around the abutment head portion 41. Preferably the liner 23 of the denture 14 is molded around the abutment shaft portion 37 and the abutment head portion 41 of the abutments 15 so the cavity is of a complementary shape with the shape of the head and shaft portions of the abutment. The ledge surface 32 of the cavity head portion 30 retains the undercut surface 44 of the abutment head portion 41. The elastic liner 23 of the denture 14 stretches to allow removal of the abutments 15 and returns to the original shape after removal. The convex shape of the end surface 46 of the abutment head portion 41 spreads the second end 28 of the cavity shaft portion 26 and aids insertion of the abutment 15 into the denture cavity 24.

The threads 55 of the implant 50 thread into the jaw bone structure 57. The gums 58 extend above the jaw bone structure 57. The length of abutment shaft portion 37 varies depending upon the height of the gums 58 above the jaw bone structure 57.

As shown in FIGS. 4 to 6, the peripheral surface 45 of the abutment head portion 41 includes a plurality of flats 59, for engagement with an insertion tool, described hereinafter. Preferably the peripheral surface 45 of the abutment head portion 41 includes ten to twelve flats 59 instead of the four or six flats on square or hexagon headed bolts. The larger number of flats 59 more closely approximates a circular shape and reduces the possible misalignment of the denture 14 due to misalignment of the peripheral surface 33 of the cavity head portion 30 relative to the peripheral surface 45 of the abutment head portion 41.

FIG. 9 shows a modification to the abutment 15 having a threaded portion 60 with external threads 61. The threaded portion 60 is sized and shaped to thread directly into bone as an implant, replacing the implant 50 described above. This modification is an integral or a one piece body so the abutment and implant is a single piece.

Referring to FIGS. 10 to 12, an insertion tool 63 has a tool head portion 65 and an engagement portion 66. The tool head portion 65 has the shape of a disk with a round, convex top surface 68, a knurled peripheral surface 69 that extends transversely from the periphery of the top surface 68 and a flat bottom surface 70 that is spaced from the top surface 68. A tool aperture 72, sized and shaped to receive a torque tool, extends into the tool head portion 65 from the center of the top surface 68. The tool aperture 72 shown has triangular shape. The tool aperture 72 can have other shapes, such as hexagonal to receive an allen wrench or star shaped to receive a torx wrench. The tool 63 may have a hole to receive a string like dental floss that is tied thereto so the tool is not swallowed.

The engagement portion 66 is a wall that projects from the center of the bottom surface 70 of the tool head portion 65, and has a circular outer surface 74 and a radially inwardly spaced inner surface 75. The inner surface 75 has a plurality of flats 76. The inner surface 75 is sized and shaped to receive and engage the flats 59 of the peripheral surface 45 of the abutment head portion 41 of the abutment 15. The insertion tool 63 facilitates tightening of the abutment 15.

The system 11 provides improved retention over prior known systems without the use of a rigid cup in the denture. Although the system 11 described is directed towards retention of dentures, the abutment 15 can also be used for retention of facial prostheses such as a nose or ear.

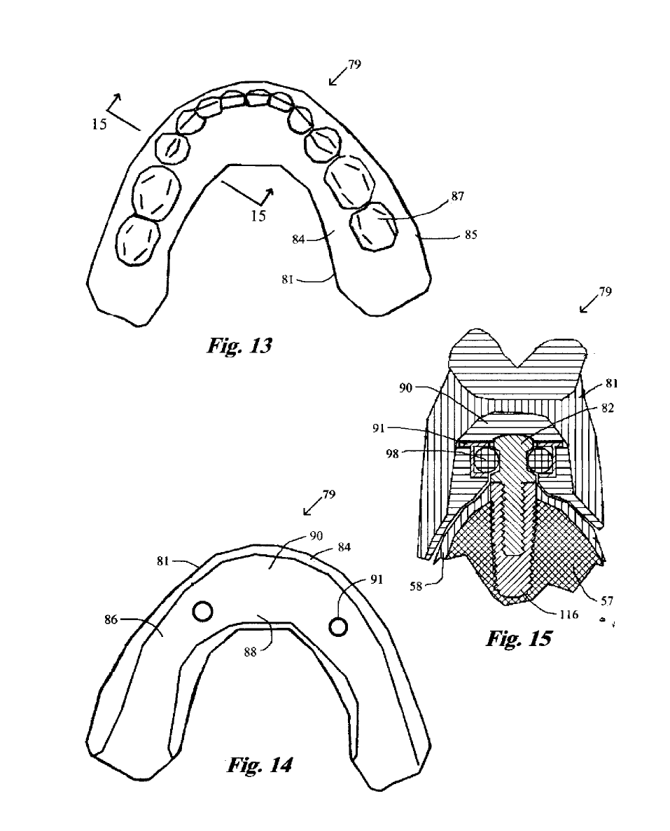

Referring to FIGS. 13 to 15, another denture retention system 79 includes a denture 81 and abutments 82. The denture 81 has a body 84 with an outer side 85 and a spaced inner side 86. The outer side 85 is shaped to simulate the appearance of gums and a plurality of artificial teeth 87 are mounted on the outer side 85. The inner side 86 has an inner channel 88 that is shaped to receive the gums of a patient. The inner channel 88 includes an elastic liner 90. The liner is made of an elastomer, a natural or synthetic elastic material. The liner 90 is preferably made of a medical silicone. By way of example, and not as a limitation, the liner 90 can be made of Silastic Type A by Dow-Corning.

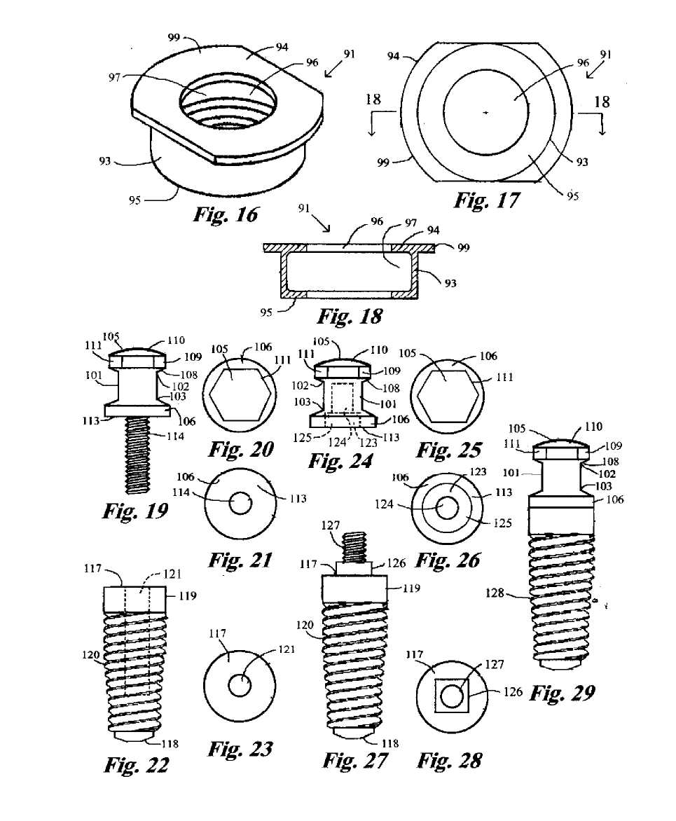

A plurality of spaced, rigid abutment inserts 91 are mounted in or molded into the liner 90. The abutment inserts 91 are substantially symmetrically positioned relative to the body 84 of the denture 81 and generally two or four abutment inserts 91 are provided. Preferably the abutment inserts 91 are made of metal, such as titanium, or rigid plastic. As shown in FIGS. 16, 17 and 18, each abutment insert 91 has a cylindrical outer wall 93, a first end wall 94 attached to and transverse to one end of the outer wall 93, and a spaced second end wall 95 attached to and transverse to the other end of the outer wall 93. The first and second end walls 94 and 95 project inwardly from the outer wall 93 to define a cylindrical abutment aperture 96 that is concentric with the outer wall 93.

The outer wall 93, and the first and second end walls 94 and 95 define an inwardly opening O-ring channel 97 around the abutment aperture 96. A resilient O-ring 98 is sized and shaped to fit into the O-ring channel 97 and project into the abutment aperture 96. The first end wall 94 has a pair of flanges 99 that project outwardly in opposite directions from the outer wall 93. The abutment inserts 91 are mounted with the flanges 99 inward in the liner 90 so that the flanges 99 anchor the abutment inserts 91 in the liner 90.

As shown in FIGS. 19 to 21, the abutment 82 includes an abutment shaft portion 101 with spaced first and second ends 102 and 103, an abutment head portion 105 attached to the first end 102 and a spaced base portion 106 attached to the second end 103. The abutment shaft portion 101 is substantially cylindrical. The abutment head portion 105 and the abutment base portion 106 each project radially outwardly relative to the abutment shaft portion 101.

The abutment head portion 105 has an undercut surface 108 that extends transversely, radially outwardly from the first end 102 of the abutment shaft portion 101, a peripheral surface 109 that extends transversely from the periphery of the undercut surface 108, and a convex end surface 110, spaced from the undercut surface 108, that extends radially inwardly from the peripheral surface 109. The peripheral surface 109 of the abutment head portion 105 includes a plurality of flats 111, for engagement with an insertion tool, such as tool 63 described above. The peripheral surface 109 of the abutment head portion 105 shown has six flats 111. The peripheral surface 109 of the abutment head portion 105 can include other numbers of flats 111.

The abutment base portion 106 has a substantially flat bottom 113. An abutment threaded portion 114 is cylindrical with external threads 115 and projects axially from the bottom 113 of the abutment base portion 113. FIGS. 22 and 23 show an implant 116 having spaced first and second ends 117 and 118. The first end 117 is flat. The implant 116 has a smooth, cylindrical surface 119 adjacent to the first end 117 and external threads 120 from the cylindrical surface 119 to the second end 118. An internally threaded implant aperture 121 extends into the implant 116 from the first end 117. The implant aperture 121 is sized and shaped to receive the abutment threaded portion 114.

Referring again to FIG. 15, the abutment shaft portion 101 is sized to fit inside the O-ring 98 in the abutment insert 91, and abutment head portion 105 is sized to project radially outwardly relative to the O-ring 98. The undercut surface 108 of the abutment head portion 105 engages the O-ring 98 to retain the denture 81. The O-ring 98 in the abutment insert 91 stretches to allow removal of the denture 81. The convex shape of the end surface 110 of the abutment head portion 105 spreads the O-ring 98 and aids insertion of the abutment 82 into the denture cavity 81. The threads 120 of the implant 116 thread into the jaw bone structure 57. The gums 58 extend above the jaw bone structure 57. The length of abutment shaft portion 101 varies depending upon the height of the gums 58 above the jaw bone structure 57.

FIGS. 24 to 26 show a modification to the abutment 82 having an abutment aperture 123. The abutment aperture 123 has a smooth cylindrical first portion 124 extending into the abutment 82 from the bottom 113 of the abutment base portion 106, and an internally threaded second portion 125 extending into the abutment 82 from the first portion 124, with the first portion 124 having a larger diameter than the second portion 125. As shown in FIGS. 27 and 28, a modified implant 116 has square shouldered tool engaging portion 126 that projects from the first end 117 of the implant 116, and an externally threaded implant threaded portion 127 that projects from the tool engaging portion 126. The tool engaging portion 126 shown is square and other shapes can be used. The tool engaging portion 126 is sized to fit into the first portion 124 of the abutment aperture 123, and the implant threaded portion 127 is sized to thread into the second portion 125 of the abutment threaded portion 123. FIG. 29 shows an abutment 82 with an externally threaded abutment threaded portion 128 that is sized and shaped to thread into the jaw bone structure 57, instead of threading into the implant 116.

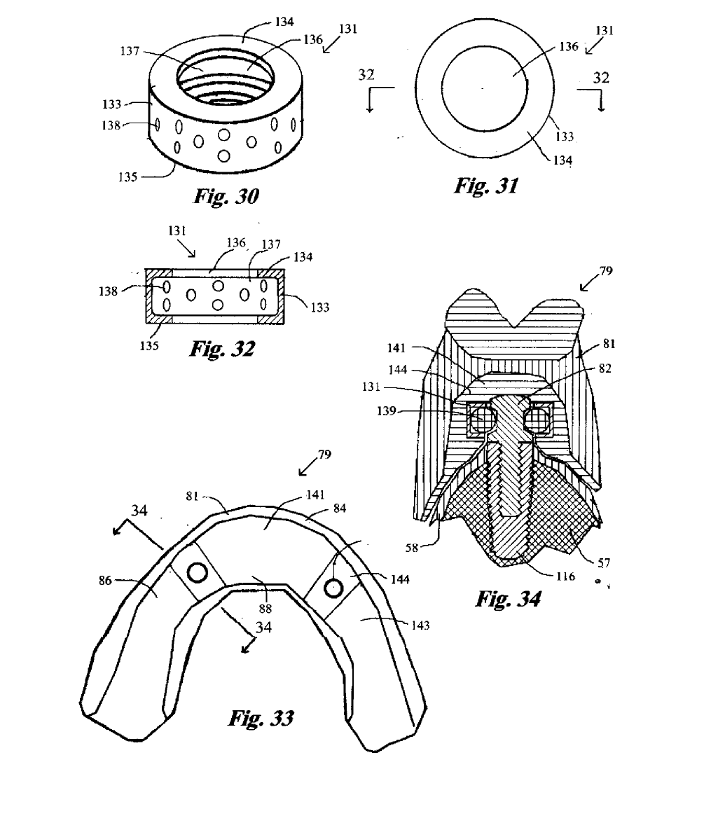

Referring to FIGS. 30 to 32, another abutment insert 131 has a cylindrical outer wall 133, a first end wall 134 attached to and transverse to one end of the outer wall 133, and a spaced second end wall 135 attached to and transverse to the other end of the outer wall 133. The first and second end walls 134 and 135 project inwardly from the outer wall 133 to define a cylindrical abutment aperture 136 that is concentric with the outer wall 133. The outer wall 133, and the first and second end walls 134 and 135 define an inwardly opening O-ring channel 137 around the abutment aperture 96. A plurality of spaced holes 138 extend through the outer wall 133 to retain the abutment insert 131 in inner channel 88. As shown in FIG. 34, a resilient O-ring 139 is sized and shaped to fit into the O-ring channel 137 and project into the abutment aperture 136.

FIGS. 33 and 34 show the denture retention system 79 with an alternative liner 141 in the inner channel 88. The liner 141 includes elastic sections 143 interspersed with spaced rigid sections 144. The elastic sections 143 are made of an elastomer, a natural or synthetic elastic material. The elastic sections 143 are preferably made of a medical silicone. By way of example, and not as a limitation, the elastic sections 143 can be made of Silastic Type A by Dow-Corning. The rigid sections 144 are made of a rigid plastic, preferably a dental acrylic. By way of example, and not as a limitation, the rigid sections 144 can be made of methyl methacrylate.

There is a rigid section 144 for each abutment insert 91 or 131, and the rigid sections 144 are selectively positioned in the inner channel 88 to receive the abutment inserts 91 or the abutment inserts 131. The rigid sections 144 provide improved retention of the abutment inserts 91 or the abutment inserts 131. Referring again to FIGS. 30 to 32, when the abutment inserts 131 are molded into the liner 90 or the rigid sections 144 of the line 141, the liner material flows into the holes 138 to retain each abutment insert 131.

Although the present invention has been described with a certain degree of particularity, it is understood that the present disclosure has been made by way of example and that changes in details of structure may be made without departing from the spirit thereof.

What is claimed is:

1. A denture retaining system comprising:
a denture having an outer side with a plurality of artificial teeth, an inner side having an inner channel, a liner in said inner channel, at least one rigid abutment insert mounted in said liner and a resilient O-ring for said abutment insert, said abutment insert having a rigid body, an abutment aperture through said body, and an inwardly opening O-ring channel around said abutment aperture sized and shaped to retain said O-ring, and
an abutment for each said insert, said abutment having an abutment shaft portion with a first end and a spaced second end, an abutment head portion attached to said first end of said abutment shaft portion and projecting radially outwardly relative to said abutment shaft portion, and a spaced abutment base portion attached to said second end of said abutment shaft portion and projecting radially outwardly relative to said abutment shaft portion, said abutment head portion having a substantially flat undercut surface that extends radially outwardly from and transverse to said abutment shaft portion, said abutment head portion being sized to extend radially outwardly relative to said O-ring,
whereby said undercut surface of said abutment head portion and said O-ring engage one another to retain said denture relative to said abutment.

2. The system as set forth in claim 1:
including an implant having a first end, a spaced second end, external threads between said first and second ends, and a threaded implant aperture extending into said implant from said first end, said external threads being sized and shaped to implant into a jaw, and
wherein said abutment includes an externally threaded portion extending from said abutment base portion opposite said abutment shaft portion and sized and shaped to thread into said implant aperture.

3. The system as set forth in claim 1:
including an implant having a first end, a spaced second end, external threads between said first and second ends, and an externally threaded implant threaded portion that projects from said first end, said external threads being sized and shaped to implant into a jaw, and
wherein said abutment includes an abutment aperture extending inwardly from said abutment base, said abutment aperture having an internally threaded portion sized and shaped to receive said implant threaded portion.

4. The system as set forth in claim 3 wherein implant includes a tool engaging portion between said first end and said implant threaded portion.

5. The system as set forth in claim 1 wherein said abutment has a threaded portion extending from said abutment base portion opposite said abutment shaft portion, said threaded portion being sized and shaped to implant into a jaw.

6. The system as set forth in claim 1 wherein said abutment head portion includes a peripheral surface that extends transversely from said undercut surface, said peripheral surface having a plurality of flats.

7. The system as set forth in claim 6 wherein said peripheral surface has six flats.

8. The system as set forth in claim 6 including an insertion tool having an engagement portion with an inner surface, said inner surface having a plurality of flats and being sized and shaped to engage said flats on said peripheral surface of said abutment head portion to turn said abutment.

9. The system as set forth in claim 8 wherein insertion tool has a tool head portion with a top surface opposite said engagement portion and a tool aperture extending into said tool head portion from said top surface, said tool aperture being sized and shaped to receive a torque imparting tool.

10. The system as set forth in claim 9 wherein said tool aperture is triangular.

11. The system as set forth in claim 1 wherein said abutment head portion has a convex end surface opposite and spaced from said undercut surface.

12. The system as set forth in claim 1 wherein said liner is elastic and made of medical silicone.

13. The system as set forth in claim 1 wherein said liner includes elastic sections interspersed with a rigid section for each said abutment insert, said rigid sections being positioned to receive said abutment inserts.

14. The system as set forth in claim 13 wherein each said rigid section is made of a dental acrylic.

15. The system as set forth in claim 1 wherein said abutment insert includes a pair of oppositely extending flanges for retaining said abutment insert in said liner.

16. The system as set forth in claim 1 wherein said abutment insert includes a plurality of spaced holes for retaining said abutment insert in said liner.

17. A denture retaining system comprising:
a denture having an outer side with a plurality of artificial teeth, an inner side having an inner channel with a liner, at least one rigid abutment insert mounted in said liner and a resilient O-ring for each said abutment insert, said abutment insert having a rigid body, an abutment aperture through said body, and an inwardly opening O-ring channel around said abutment aperture sized and shaped to retain said O-ring
an abutment for each said insert, said abutment having an abutment shaft portion with a first end and a spaced second end, an abutment head portion attached to said first end of said abutment shaft portion and projecting radially outwardly relative to said abutment shaft portion, a base portion attached to said second end of said abutment shaft portion, and an externally threaded abutment threaded portion projecting from said base portion opposite said shaft portion, said abutment head portion having a substantially flat undercut surface that extends radially outwardly from and transverse to said abutment shaft portion, a peripheral surface that extends transverse to said undercut surface, and a smooth convex end surface opposite and spaced from said undercut surface, said end surface being transverse to and connected to said peripheral surface, said peripheral surface having six flats, said abutment head portion being sized to extend radially outwardly relative to said O-ring,
an implant having a flat first end, a spaced second end, external threads between said first and second ends, and a threaded implant aperture extending into said implant from said first end, said external threads being sized and shaped to implant into a jaw, said implant aperture being sized and shaped to receive said abutment threaded portion, and
whereby said undercut surface of said abutment head portion and said O-ring in said abutment insert retain said denture relative to said abutment.
